(19) United States
(12) Patent Application Publication
(10) Pub. No.: US 2018/0350167 A1
(43) Pub. Date: Dec. 6, 2018

(54) AUTOMATIC DETECTION OF VEHICULAR MALFUNCTIONS USING AUDIO SIGNALS

(71) Applicant: Faraday&Future Inc., Gardena, CA (US)

(72) Inventors: Luke Michael Ekkizogloy, Mountain View, CA (US); Sethu Hareesh Kolluru, Fremont, CA (US); Michael Lambertus Hubertus Brouwer, Los Gatos, CA (US); Yunwei Liu, Alameda, CA (US)

(21) Appl. No.: 15/613,089

(22) Filed: Jun. 2, 2017

Related U.S. Application Data
(60) Provisional application No. 62/345,727, filed on Jun. 3, 2016.

(51) Int. Cl. G07C 5/08; B60R 11/02; G08G 1/01; G08G 1/0968

(52) U.S. Cl. CPC G07C 5/0808; G08G 1/0968; G08G 1/0141; B60R 11/0247

(57) ABSTRACT

In some embodiments, a method for determining a vehicle malfunction includes receiving audio data from at least one microphone disposed on a vehicle, inputting the audio data into an analysis module having a trained model, and obtaining, from the analysis module, a hypothesized vehicular malfunction condition based on the audio data. The audio data may corresponding to sounds generated by the vehicle, and the trained model may associate various audio data and corresponding vehicular malfunction conditions. The method can further include inputting sensor data into the analysis module having the trained model, the sensor data from at least one sensor disposed on the vehicle. The trained model can further associates various sensor data, along with the various audio sounds, and the corresponding vehicular malfunction conditions, and the hypothesized vehicular malfunction condition obtained from the analysis module can be based on the audio data and the sensor data.

### CROSS-REFERENCE TO RELATED APPLICATIONS

This application claims the benefit of U.S. Provisional Application No. 62/345,727, filed Jun. 3, 2016, the entirety of which is hereby incorporated by reference.

### BACKGROUND

Automotive vehicles can be complicated machines with many moving parts that can wear out and break over time. If caught early enough, preemptory measures can potentially reduce repair costs and may save lives. In conventional systems, electronic control systems in vehicles typically rely on an array of sensors to measure the operative parameters of the engine and other systems. Some of these conventional sensors can include engine temperature sensors, oil pressure sensors, oil temperature sensors, coolant temperature sensors, oxygen sensors, tire pressure sensors, and the like. Usually, conventional sensors only detect a problem after it occurs because the failure mode results in a sensor detecting an out-of-nominal signal. As such, engine failure (or any vehicle system failure) can occur anywhere and at any time and the driver typically does not have the benefit of knowing that a failure is imminent to take corrective actions and plan accordingly. Furthermore, some diagnoses may be too complex or difficult to make using conventional sensor readings. In some cases, certain failure modes or states of deterioration may even be completely undetectable using conventional sensor technology. Better methods and systems are needed for detecting and diagnosing vehicular problems before a failure mode occurs.

### BRIEF SUMMARY

In certain embodiments, a computer-implemented method for determining a vehicle malfunction may include: receiving, by a processor, audio data from at least one microphone disposed on a vehicle, the audio data corresponding to sounds generated by the vehicle; inputting, by the processor, the audio data into an analysis module having a trained model, the trained model associating various audio data and corresponding vehicular malfunction conditions; and obtaining, by the processor, from the analysis module, a hypothesized vehicular malfunction condition based on the audio data.

In some embodiments, the method can further include inputting, by the processor, sensor data into the analysis module having the trained model, the sensor data from at least one sensor disposed on the vehicle, where the trained model further associates various sensor data, along with the various audio sounds, and the corresponding vehicular malfunction conditions, and where the hypothesized vehicular malfunction condition obtained from the analysis module can be based on the audio data and the sensor data. In some cases, the sensor data can correspond to at least one vehicle performance characteristic and the trained model can be trained by machine learning.

In certain embodiments, the method can further include receiving, by the processor, global positioning system (GPS) data corresponding to a present location of the vehicle, where the hypothesized vehicular malfunction condition obtained from the analysis module is based on the audio data and the GPS data. In further embodiments, the method can include receiving, by the processor, traffic data corresponding to traffic local to a present location of the vehicle, where the hypothesized vehicular malfunction condition obtained from the analysis module is based on the audio data and the traffic data. In some implementations, the various audio data and corresponding vehicular malfunction conditions can be stored and retrieved from a database, and the received audio data can be added to the various audio data and corresponding vehicular malfunction conditions in the database.

In some embodiments, a system can include one or more processors, and one or more non-transitory computer-readable storage mediums containing instructions configured to cause the one or more processors to perform operations including: receiving, by a processor, audio data from at least one microphone disposed on a vehicle, the audio data corresponding to sounds generated by the vehicle; inputting, by the processor, the audio data into an analysis module having a trained model, the trained model associating various audio data and corresponding vehicular malfunction conditions; and obtaining, by the processor, from the analysis module, a hypothesized vehicular malfunction condition based on the audio data.

In certain embodiments, the system can further include instructions configured to cause the one or more processors to perform operations including inputting, by the processor, sensor data into the analysis module having a trained model, the sensor data from at least one sensor disposed on the vehicle, where the trained model further associates various sensor data, along with the various audio sounds, and the corresponding vehicular malfunction conditions, and where the hypothesized vehicular malfunction condition obtained from the analysis module can be based on the audio data and the sensor data. In some cases, the sensor data can correspond to at least one vehicle performance characteristic, and the trained model can be trained by machine learning.

In further embodiments, the system may include instructions configured to cause the one or more processors to perform operations including receiving, by the processor, GPS data corresponding to a present location of the vehicle, where the hypothesized vehicular malfunction condition obtained from the analysis module is based on the audio data and the GPS data.

In some embodiments, the system can further include instructions configured to cause the one or more processors to perform operations including receiving, by the processor, traffic data corresponding to traffic local to a present location of the vehicle, where the hypothesized vehicular malfunction condition obtained from the analysis module can be based on the audio data and the traffic data. In some implementations, the various audio data and corresponding vehicular malfunction conditions can be stored and retrieved from a database, and the received audio data can be added to the various audio data and corresponding vehicular malfunction conditions in the database.

In further embodiments, a system for determining a vehicle malfunction can include: a means for receiving audio data from at least one microphone disposed on a vehicle, the audio data corresponding to sounds generated by the vehicle; a means for inputting the audio data into an analysis module having a trained model, the trained model associating various audio data and corresponding vehicular malfunction conditions; and a means for obtaining from the analysis module, a hypothesized vehicular malfunction condition based on the audio data.

In certain implementations, the system can further include a means for inputting sensor data into the analysis module having a trained model, the sensor data from at least one sensor disposed on the vehicle, where the trained model can further associate various sensor data, along with the various audio sounds, and the corresponding vehicular malfunction conditions, and where the hypothesized vehicular malfunction condition obtained from the analysis module can be based on the audio data and the sensor data. The sensor data may correspond to at least one vehicle performance characteristic and the trained model can be trained by machine learning. The system can further include a means for receiving GPS data corresponding to a present location of the vehicle, where the hypothesized vehicular malfunction condition obtained from the analysis module can be based on the audio data and the GPS data. In some cases, the system can further include a means for receiving traffic data corresponding to traffic local to a present location of the vehicle, where the hypothesized vehicular malfunction condition obtained from the analysis module can be based on the audio data and the traffic data.

### BRIEF DESCRIPTION OF THE DRAWINGS

The detailed description is set forth with reference to the accompanying figures.

FIG. 1 shows a simplified diagram of an undercarriage of a vehicle including common vehicular systems that can be prone to failure over time.

FIG. 2 shows a simplified diagram of an array of microphones placed around an audio source, according to certain embodiments.

FIG. 3 shows a graph of audio recordings for a multi-microphone array, according to certain embodiments.

FIG. 4 shows a simplified block diagram of a system for automatically detecting vehicular malfunctions using audio signals, according to certain embodiments.

FIG. 5 shows a simplified block diagram of a system for automatically detecting vehicular malfunctions using audio signals, sensor data, and environmental data, according to certain embodiments.

FIG. 6 is a graph showing a correlation of an audio signal from a microphone on a vehicle with a sensor measurement from a steering wheel, according to certain embodiments.

FIG. 7 shows a simplified block diagram of a system including a vehicle and a fully contained system for automatically detecting vehicular malfunctions using audio signals, according to certain embodiments.

FIG. 8 shows simplified block diagram of a system including a number of vehicles communicatively coupled to the cloud for automatically detecting vehicular malfunctions using audio signals, according to certain embodiments.

FIG. 9 shows a simplified flow chart for automatically detecting vehicular malfunctions using audio signals, according to certain embodiments.

FIG. 10 shows a simplified flow chart for automatically detecting vehicular malfunctions using audio signals, according to certain embodiments.

FIG. 11 shows a simplified block diagram of a computer system for performing certain aspects of automatically detecting vehicular malfunctions using audio signals, according to certain embodiments.

### DETAILED DESCRIPTION

Aspects of the present disclosure relate generally to vehicular systems, and in particular to systems and methods for automating the detection of vehicular malfunctions using audio signals and machine learning algorithms, according to certain embodiments.

In the following description, various embodiments of vehicular systems will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

An audio signature may be a good indicator of a vehicle's operational state. For example, some audio signatures may be indicative of satisfactory performance, while others may indicate a component malfunction or the onset thereof (e.g. overly worn brake pads or rotors). In some embodiments, an array of microphones (i.e., sensors) are positioned around an interior and/or exterior of a vehicle. Processor-controlled machine learning algorithms can be used to determine what a “normal” running state of the vehicle is over time. If the sensors detect a audio signature that is slightly abnormal or transient (i.e., anomalous), it can alert the driver (or processing logic) of the situation in advance and can cross-reference a database of possible issues to diagnose the most likely cause of the anomaly. Further, an array of microphones can be used to trilaterate the precise location of the audio signature in question. Thus, preemptive measures and servicing (repairs) may be performed to potentially avoid costly repairs or catastrophic failures that otherwise may have occurred.

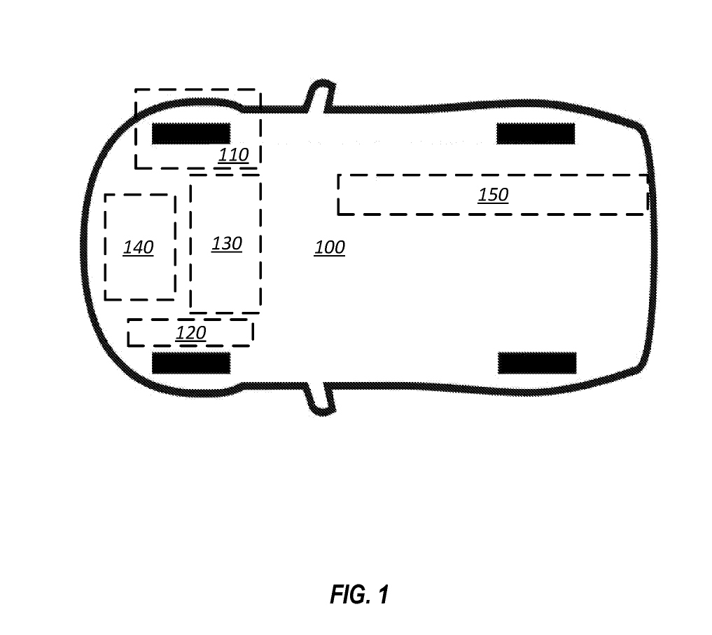

FIG. 1 shows a simplified diagram of an undercarriage of vehicle 100 including common vehicular systems that can be prone to failure over time. Vehicle 100 includes wheel components 110, suspension systems 120, steering control systems 130, propulsion system 140, and exhaust system 150. The systems shown and discussed herein are not limiting; other systems or subsystems (e.g., fuel lines, electrical charging systems, battery packs, electronic control systems, etc.) may also exhibit failure mechanisms that can be diagnosed using audio signals in accordance with the present disclosure, as would be understood by one of ordinary skill in the art.

Wheel components 110 can include rims, tires, or other features associated with the wheels of a vehicle. Some audio signatures that may be indicative of component failure or the onset thereof may include flat or underinflated tires, brake wear, uneven tread wear due to alignment or wheel balancing problems, and the like, with each having a corresponding audio signature.

Suspension systems 120 can include shocks, struts, coil springs, leaf springs, torsion bars, and the like. Some audio signatures indicative of component failure or the onset thereof in suspension systems may include squeaking, grinding, or other noises that commonly occur is failing suspension systems, with each having a corresponding audio signature.

Steering control system 130 is associated with steering vehicle 100 and may include rack-and-pinion systems, axles, tie rods, steering arms, and the like, with each having a corresponding audio signature. Some audio signatures indicative of component failure or the onset thereof in steering control systems may include squeaking, grinding, or other noises that commonly occur in failing steering control systems.

Propulsion system 140 can include systems associated with propelling the vehicle, such as an engine block, starter systems, alternator, cooling systems, fuel systems, battery systems (e.g., lithium-ion batteries designed for electric vehicles, battery cooling systems, fire-resistant batteries) and the like, with each having a corresponding audio signature. Some audio signatures indicative of component failure or the onset thereof in engines may include squeaking (e.g., belts), clicking (e.g., starter motor), pinging (e.g., engine block), or other noises that may commonly occur in certain categories of propulsion systems. Propulsion system 140 can be an internal combustion engine, electric motor, hybrid motor (e.g., internal combustion and electric), hydrogen fuel-cell-based motor, or any suitable device that can provide automotive power to the vehicle.

Exhaust system 150 can include an exhaust manifold, tail pipe, catalytic converter, and the like, with each having a corresponding audio signature. Some audio signatures indicative of component failure or the onset thereof in exhaust system may include abnormally loud exhaust, metal-on-metal banging (e.g., a loose exhaust system), or other noises that are commonly associated with faulty exhaust systems, as would be understood by one of ordinary skill in the art.

Vehicle 100 can be any suitable vehicle including a passenger vehicle (e.g., car, pickup, motorcycle, etc.), commercial vehicle (e.g., trucks, tractors, semi-trucks, heavy equipment), or the like, and of any type (e.g., electric vehicle, internal combustion-based vehicle, diesel vehicle, hybrid vehicle, fuel-cell-based vehicle, etc.).

### Audio Source Location Detection

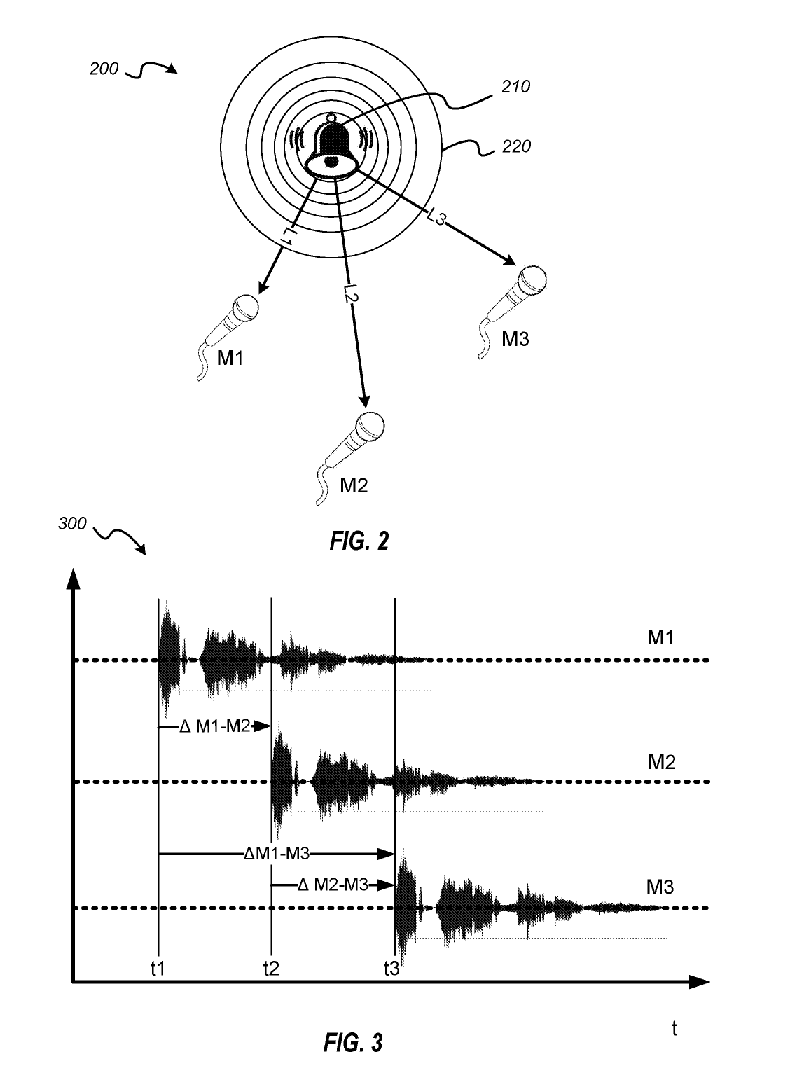

FIG. 2 shows a simplified diagram 200 of an array of microphones M1-M3 placed around an audio source 210, according to certain embodiments. Using multiple microphones disposed at different positions with respect to an audio source can both improve the fidelity of the recording and provide audio location capabilities using audio phase and/or timing analysis, as further discussed below. Referring to FIG. 2, audio source 210 emits an audio signal 220, which is picked up by microphones M1-M3. Microphone M1 is at a distance L1 from audio source 210, microphone M2 is at a distance L2 from audio source 210, and microphone M3 is at a distance L3 from audio source 210. Each microphone M1-M3 can be disposed at a different position with respect to audio source 210. As shown in the example portrayed in FIG. 2, M1 is the closest and M2 is the farthest way from audio source 210. Each microphone M1-M3 may receive audio signal 220 (i.e., audio data) at a different time depending on their relative position with respect to audio source 210. These time differences can be calculated (i.e., as phase differences), which may be used to determine the location of audio source 210, such as by trilateration, as would be understood by one of ordinary skill in the art.

While FIG. 2 illustrates three microphones M3 for clarity of illustration, more than three microphones may be used for audio source location, according to certain embodiments of the present disclosure. Specifically, three microphones may allow the 2-dimensional (2D) location of the audio source within a plane to be determined. However, by increasing the number microphones to four or more microphones, the 3-dimensional (3D) location of the audio source within a volumetric space such as an interior cabin of a vehicle may be determined. This may identify not only the horizontal 2D location (e.g., X and Y location) of the audio source, but also its vertical height (e.g., Z location). According to some embodiments, the addition of vertical height location may facilitate more refined and precise speaker identification and/or isolation, as passengers may be differentiated not only by where they might typically sit in the vehicle, but also by their physical height while in a sitting position.

FIG. 3 shows a graph 300 of audio recordings for a multi-microphone array, according to certain embodiments. Returning to a simple three-microphone example, graph 300 depicts amplitude vs. time for the audio data received by each of microphones M1-M3, as shown in FIG. 2. Microphone M1 receives audio signal 220 beginning at time t1, microphone M2 receives audio signal 220 beginning at time t2, and microphone M3 receives audio signal 220 beginning at time t3. As mentioned above, the time deltas between the received signals (e.g., Δ M1-M2, Δ M1-M3, Δ M2-M3) can be used to determine a location of audio source 210 using conventional trilateration techniques including time difference of arrival (TDOA), cross-correlation functions between audio signals, and geometric principles, as would be understood by one of ordinary skill in the art.

### Automatic Detection of Vehicular Malfunctions Using Audio Signals

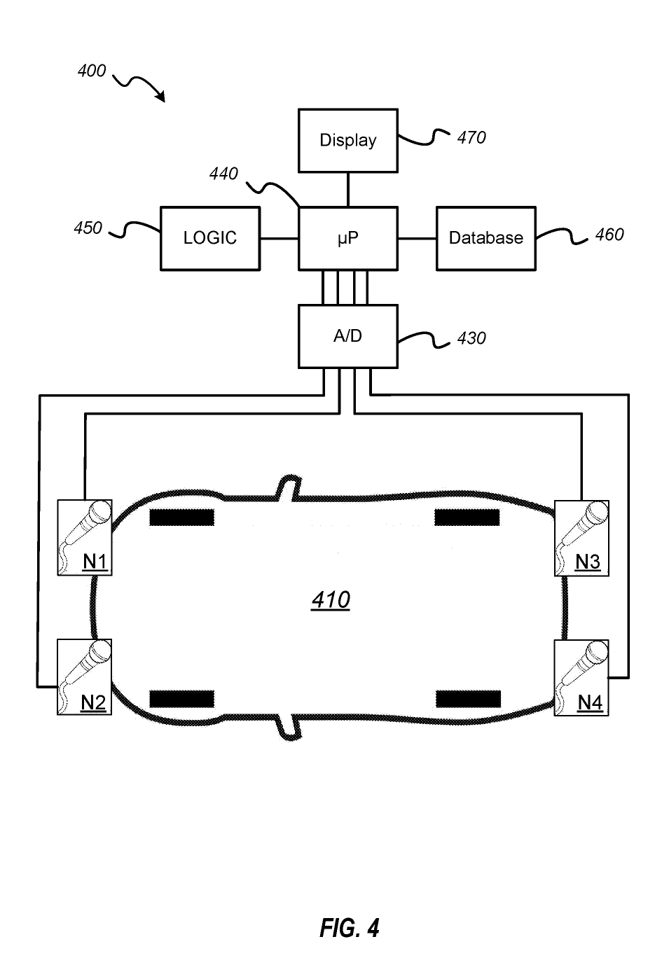

FIG. 4 shows a simplified block diagram of a system 400 for automatically detecting vehicular malfunctions using audio signals, according to certain embodiments. System 400 can include a vehicle 410, two or more microphones (N1-N4), analog-to-digital converter (A/D) 430, one or more microprocessors 440, logic 450 (i.e., software stored in memory), database 460, and display 470. Each of system blocks 430, 450, 460 and microphones N1-N4 can be in electrical communication with processor 440. It should be noted that while FIG. 4 includes a “top down” view showing microphones N1-N4 seemingly arranged within a flat plane, microphones N1-N4 may in fact be installed at different vertical heights in order to obtain a 3-D location of the audio source.

Vehicle 410 can include any type of vehicle (e.g., passenger vehicle, commercial vehicle, etc.). Microphones N1-N4 may be disposed around the undercarriage of vehicle 410 to detect vehicular sounds (i.e., nominal and anomalous operational sounds) including, but not limited to, the various systems described above with respect to FIG. 1. In some embodiments, microphones N1-N4 can be disposed in the cabin of vehicle 410 (but near the undercarriage), on the undercarriage (e.g., exposed to the elements, a location in between, or any combination thereof. Microphones N1-N4 can be any suitable type of microphone including dynamic or condenser microphones (among other types including ribbon, carbon, piezoelectric, fiber optic, laser, liquid, MEMS, or the like). Some embodiments may utilize omnidirectional microphones to detect sounds from any portion of vehicle 410. In some implementations, directional microphones can be used for certain applications (e.g., focused audio recording of specific systems). Any plurality of microphones can be used in system 400. In some embodiments, microphones N1-N4 may be servo-controlled to directionally alter their audio-focus. Some microphones may be adjustable to switch between omni-directional and directional focus. Referring to FIG. 4, microphones N1-N4 are installed on the undercarriage of vehicle 410 (e.g., on the frame). However, microphones can be installed in any suitable location. Vehicular sounds from particular audio sources can be referred to as audio signals or audio signatures. The collective audio received (i.e., from multiple audio sources including white noise) can be generally referred to as audio data.

A/D 430 can convert analog signals into digital signals to feed into processor 440 for computational analysis. Audio signals can typically be wave files having analog properties (e.g., amplitude, frequency, and/or time components). In some embodiments, A/D operations can be integrated into one or more other components of system 400 (e.g., processor 440). A/D usage and implementation would be understood by one of ordinary skill in the art.

In some embodiments, processor 440 can include one or more microprocessors (μCs) and may control the execution of software (e.g., logic, database management, access, and retrieval), controls, and communication between various electrical components of system 400. In some cases, processor 440 may include one or more microcontrollers (MCUs), digital signal processors (DSPs), or the like, with supporting hardware and/or firmware (e.g., memory, programmable I/Os, etc.), as would be understood by one of ordinary skill in the art.

Display 470 can display images, messages, alerts, and the like, using any suitable image generation technology, e.g., a cathode ray tube (CRT), liquid crystal display (LCD), light emitting diode (LED) including organic light emitting diodes (OLED), projection system, or the like. For example, when an anomalous audio signature is detected, cross-referenced with database 460, and identified (as further discussed below), a message can be sent to display 470 to alert the driver that a failure mode has occurred or is likely to occur.

Logic 450 can be implemented in software, firmware, hardware, or a combination thereof, to analyze the audio data received from microphones N1-N4. In some embodiments, logic 450 can calculate the location of an audio source based on phase differences between the audio data received from each microphone, as discussed above. Logic 450 can further be used to analyze and determine audio characteristics of the audio data including amplitude, frequency, and/or phase content (e.g., timing data), isolating multiple audio sources, real-time and post-processing for filtering or improving the fidelity of the audio data, comparing audio data with data stored in database 460 (discussed below), or the like. In some embodiments, logic 450 can filter or attenuate certain audio signals if they are substantially common mode signals (i.e., having no substantial phase difference between them).

In some implementations, logic 450 can control an orientation or focus of one or more of microphones N1-N4 (e.g., via servo control) for location-targeted audio reception. Alternatively or additionally, logic 450 can control amplifier settings associated with one or more microphones N1-N4 to achieve audio signal beam forming, thereby realizing location-targeted audio reception. For example, when logic 450 determines that a certain audio source is in a specific location (e.g., right-front strut), microphones N1-N4 may be adjusted to focus audio sensing on reception of sound waves coming from the specified location and suppress reception of sound waves coming from elsewhere. Such location-targeted audio reception facilitates improved fidelity (e.g., better signal-to-noise (S/N) ratio, better signal-to-interference (S/I) ratio, etc.).

In some embodiments, logic 450 can employ a learning algorithm to expand, over time, the parameters of what “normal” operating conditions (and anomalous operating conditions) may be. For instance, logic 450 can store audio in database 460 corresponding to sounds generated by vehicle 410 over the course of several years to build a large library of “normal” operating parameters in different environments (e.g., locations, climate, road conditions, etc.) and different states of operation (e.g., at different speeds, suspension settings, etc.), which can help logic 450 better characterize and determine which audio signatures are within normal parameters and which are anomalous. In some cases, database 460 can be recursively updated as new failure mechanisms occur (or are received by the cloud via crowd sourcing). For instance, a previously unidentified anomalous audio signature that occurred prior to a component malfunction (e.g., exhaust support hardware breakage) can be associated with that particular malfunction for future diagnoses.

Database 560 can be implemented in software, firmware, hardware, or a combination thereof. Database 460 can be an audio reference library to be used to compare audio signatures from an audio source on vehicle 410 with sounds (audio signatures) stored on database 460 that are known to be indicative of normal operation, a failure mode, or the onset of a failure mode.

In some embodiments, database 460 may contain audio samples (audio signatures) of how vehicle 410 sounds when driving under normal operating conditions. Database 460 may include normal driving conditions over varied surfaces (roads, highways, unpaved roads, pot hole-filled roads, wet or snow covered surfaces, etc.), varied weather conditions (cold/warm/hot climates, precipitation, high winds, etc.), etc. Database 460 can expand the audio library over time for vehicle 410 to create improved and expanded reference content over more varied operating conditions.

In some embodiments, database 460 may contain audio samples (audio signatures) of how vehicle 410 sounds when driving under abnormal operating conditions (i.e., atypical or anomalous audio signatures). Database 460 may include audio signatures of failure mechanisms for any of components 110-150 (or other components not shown) of FIG. 1. For example, database 460 can include audio signatures of various states of brake degradation including rotor grinding, rusty rotors, brake shoe degradation, and the like. Database 460 can include audio signatures of various states of exhaust system degradation (e.g., holes, mounting hardware issues, etc.), engine degradation (e.g., idling irregularities, belt/pulley degradation or misalignment, suspension degradation), and the like. Database 460 can be stored on vehicle 410, stored in the cloud (not shown), or a combination thereof. In some embodiments, database 460 can be enhanced by crowd sourcing data (e.g., via the cloud) for the specific make and model of vehicle 410 for a more robust reference database. In further embodiments, processing and logic can also be pushed to the cloud for further processing instead of, or in conjunction with, processor 440, logic 450, and database 460. The many modifications, variations, and alternatives would be understood by one of ordinary skill in the art.

In a non-limiting example, when microphones N1-N4 detect an audio source generating a loud screeching sound (audio signature), logic 450 can determine its location (using phase differences between audio signals), and compare the screeching audio signature with sounds on audio database 460. In some cases, the location of the audio source can be used to filter the total number of stored audio signatures. For example, if the location of the audio source is determined to be near the wheel well of vehicle 410, the reference audio signatures can be limited to those associated with wheels, brakes, or connecting/steering components local to that particular location. When a match is determined (e.g., excessive brake wear), an alert can be sent to display 470 to inform the driver of the failure mechanism.

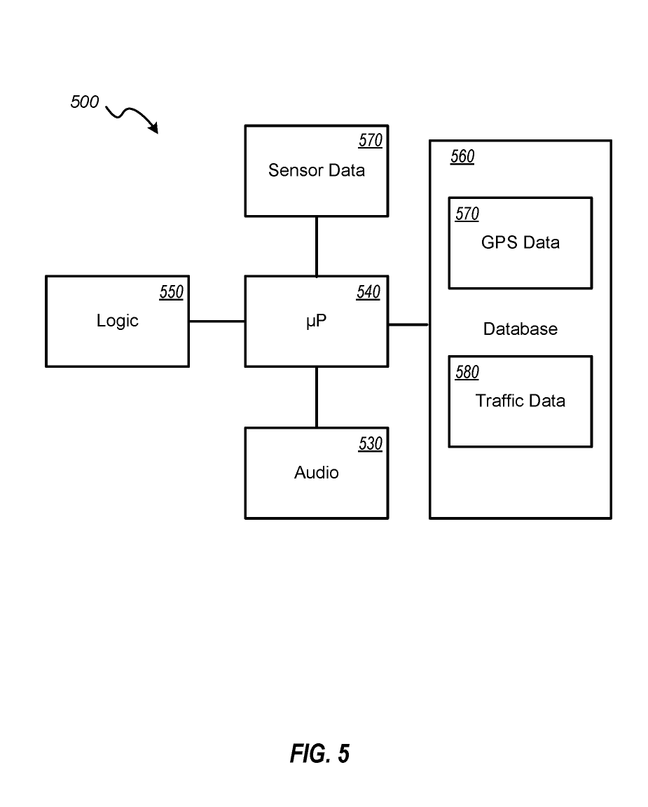

FIG. 5 shows a simplified block diagram of a system 500 for automatically detecting vehicular malfunctions using audio signals, sensor data, and environmental data, according to certain embodiments. System 500 can be similar to system 400 (i.e., includes vehicle 110, microphones N1-N4, etc.) with the addition of GPS data 570 and traffic data 580 as part of database 560 and sensor data 570.

Audio block 530 can include audio data received from a plurality of microphones (e.g., microphones N1-N4) in addition to supporting audio circuitry (e.g., A/D converters, audio filters, etc.), as discussed above with respect to FIG. 4.

Sensor Data 570 can include data received from sensors other than microphones that can be used to help system 500 determine the cause of certain audio signatures. For example, sensor data 570 may include pressure sensor data (e.g., from passenger seats) that indicate whether passengers are sitting in a corresponding seat in the vehicle cabin. Knowing whether a vehicle is loaded (e.g., 600 lbs. of driver and passenger weight) or not (e.g., 150 lbs. driver weight) can modify the expected audio signatures that might be caused by a suspension system. In such instances, system 500 (i.e., logic block 550) can compare audio data received from suspension systems (audio signatures) to a more appropriate audio reference (e.g., suspension under heavy load vs. suspension under light load) for a more accurate analysis. In another example, a driver may be playing music using a very high power audio system that may cause vibrations throughout the vehicle. These vibrations may be transferred to various components (e.g., vehicle components 110-150) of the vehicle, which could artificially induce a false positive anomalous sound (audio signature) in vehicle components that would otherwise not be vibrating or generating sound. As such, logic 550 can use non-audio sensor data to help diagnose the cause of certain anomalous audio signatures. Sensor data can include data corresponding to a vehicle performance characteristic, infotainment system characteristic, vehicle setting characteristic, or the like.

In some embodiments, GPS data 570 may be part of database 560. GPS data 570 can be useful in helping logic 550 filter and/or modify audio data based on a location of the vehicle. For instance, an interstate highway may include significantly more background noise (e.g., white noise) than a rural country road. However, the country road may be ridden with pot holes, rocks, and uneven sections, causing vehicular components (e.g., suspension systems, steering control systems, etc.) to respond differently than they would on a well-maintained highway. Logic 550 can use the GPS data to factor in location information (i.e., environmental data) to modify a comparison of an anomalous audio signature with a more appropriate audio reference (e.g., reference audio signatures with matching location/environmental data) for a more accurate analysis.

In some embodiments, traffic data 580 may be part of database 560. Traffic data 580 can be useful in helping logic 550 filter and/or modify audio data based on local traffic conditions. Heavy traffic may introduce increased amounts of white noise (which can be cancelled as a common mode signal), anomalous sounds (audio signatures) from adjacent cars (which may be filtered out if the audio source is located by analyzing audio phase differences), and can inform vehicle driving conditions (e.g., frequent starting/stopping, etc.), which may affect vehicle component performance (e.g., suspension systems). This may help logic 550 select a more appropriate database reference for comparison with an anomalous audio signal.

Other sensor and/or environmental data can be used to further improve audio data analysis including the time, weather conditions, vehicle speed, etc., as would be appreciated by one of ordinary skill in the art.

### Correlating Sensor Signals With Audio Signals

In some embodiments, sensor data 570 can be correlated with audio data to help diagnose certain vehicular malfunctions. For instance, sensor data 570 and audio data can be correlated based on time to help determine the cause of an anomalous audio signal. For example, logic 550 may determine that an anomalous audio signal only occurs when an A/C compressor is turned on or when the engine RPMs rise above a certain threshold value. In some cases, more complex relationships may be discovered. For example, a particular sound (anomalous audio signal) may only occur when a state-of-charge of a battery in an electric vehicle or plug-in hybrid is at or below a certain value, the A/C is on, and the infotainment system is in a particular mode of operation. Machine learning operations may be well-suited for these types of scenarios. For instance, logic 550 may determine, over time, that only one of the many combinations of states that each of the battery, A/C, and infotainment system are in at any given time may tend to cause the anomalous audio signal to occur. Using machine learning, logic 550 can look for instances in previous data logs (e.g., in a storage device, database 560, etc.) where the anomalous audio signal has occurred, and back test the determined combination of states over a period of time (e.g., a month) to verify if the relationship between the anomalous audio signal and the combination of states of the battery, A/C, and infotainment system is conclusive. It should be understood that in some embodiments, phase analysis can be used to determine that a noise is outside of a vehicle. For example, common noises found outside of a vehicle may have a signature which can be detected using phase analysis. Noises found outside of a vehicle may include wind noise, noise from storms, hail, or other types of whether, noise from trucks passing by a vehicle, noise from trains, and/or noise from music emanating from outside of a vehicle.

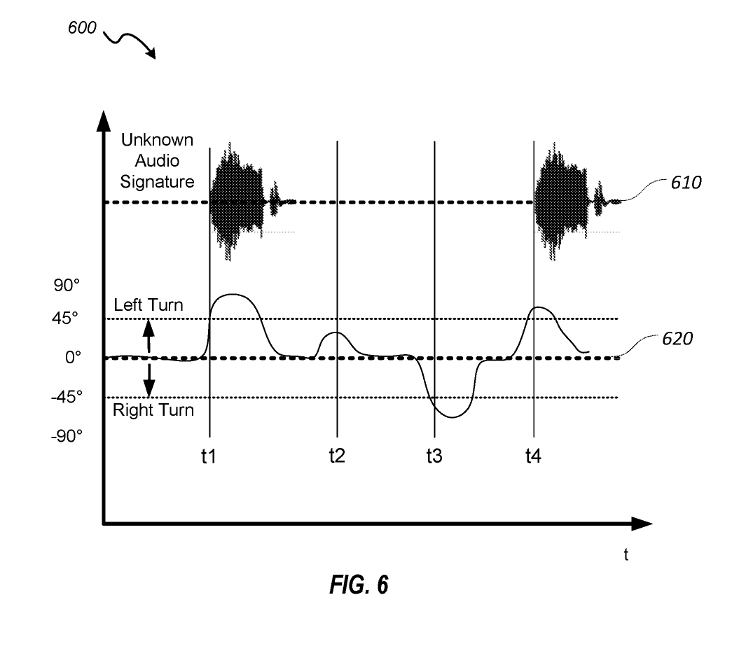

FIG. 6 is a graph 600 showing a correlation of an audio signal from a microphone (e.g., M1, N1, etc.) on a vehicle with a sensor measurement from a steering wheel, according to certain embodiments. Signal 610 can be an anomalous audio signature versus plotted versus time that may be indicative of a failure mode in vehicle 410. Signal 620 can correspond to a rotation of a steering wheel on vehicle 410. Positive signals may correspond to left turns with the steering wheel, and negative signals may correspond to right turns. The amplitude of the signal may correspond to an amount that the steering wheel is turned (e.g., measured in degrees).

At time t1, the anomalous audio signal occurs and the steering wheel sensor contemporaneously reports a rotation of the steering wheel at 45 degrees to the left. Logic 450 can flag the correlation and store it for future reference (e.g., in local storage, database 460, in the cloud, etc.). At time t2, the steering wheel sensor reports a rotation of the steering wheel at 23 degrees to the left with no contemporaneous anomalous audio signal. At time t3, the steering wheel sensor reports a rotation of the steering wheel at 55 degrees to the right with no contemporaneous anomalous audio signal. At this time, logic 550 may, for example, determine that there is not a strong correlation between turning the steering wheel and the anomalous signal in general. At time t4, the anomalous audio signal occurs and the steering wheel sensor contemporaneously reports a rotation of the steering wheel at 65 degrees to the left. At this time, logic 550 may recognize that there is some correlation between left turns beyond 45 degrees and the anomalous audio signal. Using aspects of machine learning, logic 550 can use repeat occurrences of the anomalous audio signal to modify the determined correlation and provide more accurate analyses. Alternatively or additionally, logic 550 can back test the correlation to see if the anomalous audio signal occurred in previous instances when the steering wheel was turned left at 45 degrees. For instance, logic 550 may determine that the anomalous audio signal is less and less pronounced (i.e., smaller amplitude) further back in time. In such instances, logic 550 may further deduce that the anomalous audio signal began at a particular time frame and can cross-reference other events (e.g., other sensors, calendar events, environmental data, etc.) to pinpoint a specific cause. For example, logic 550 may determine that the anomalous audio signal began occurring after a maintenance service was performed on the vehicle. Those of ordinary skill in the art with the benefit of this disclosure would recognize the many examples, applications, combinations, variations, cross-referenced analyses, etc., that are possible in embodiments using the techniques discussed above.

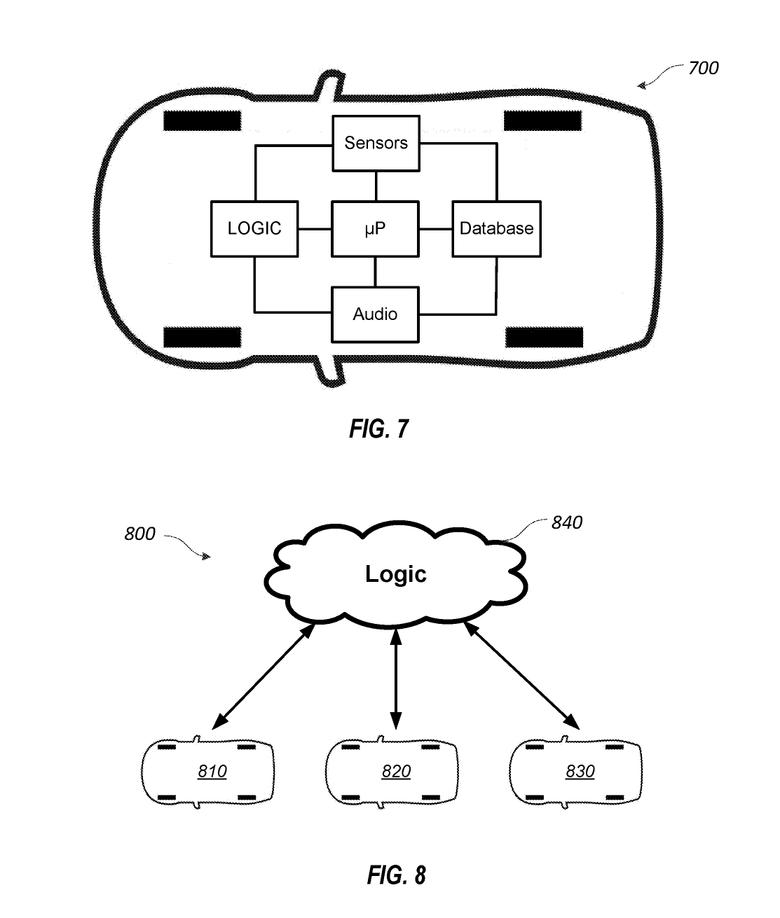

FIG. 7 shows a simplified block diagram of a system 700 including a vehicle and a fully contained system for automatically detecting vehicular malfunctions using audio signals, according to certain embodiments. System 700 can be all-inclusive such that all logic processing (audio analysis, location detection) and database comparison is performed by components on the vehicle. In some embodiments, communication capabilities (e.g., via cellular, Wi-Fi, ZigBee, RF, etc.) can be used to connect system 700 to the cloud or to other vehicles for crowd sharing/sourcing database data (e.g., crowd sharing data to enhance and improve database reference data).

FIG. 8 shows simplified block diagram of a system 800 including a number of vehicles communicatively coupled to the cloud for automatically detecting vehicular malfunctions using audio signals, according to certain embodiments. In system 800, each vehicle 810-830 can offload resources configured for automatic detection of vehicular malfunctions to off-site resources in cloud 840. In some embodiments, cloud 840 may contain logic (as described above), a database, and one or more processors to execute some or all aspects of the analysis discussed above. For example, vehicle 810 may receive audio data from a local array of microphones and transfer the audio data to the cloud to determine a location of the audio source (of the audio data) using phase analysis (as discussed above with respect to FIGS. 2-3). The cloud can further compare the audio data with a database stored on the cloud to diagnose any anomalous audio signatures. The database (as described throughout this disclosure) can include a collection of audio data provided by the specific vehicle and can further include data crowd sourced by many vehicles. The database can further include more complex information on the correlation between audio signals with other data (e.g., vehicle performance data, environmental data, etc.), or the like, as discussed above with respect to FIG. 6. The cloud can be any suitable size of networked computing devices that may be configured to share computational resources. The many variations and alternatives of sharing resources between individual vehicles (e.g., vehicles 810-830) and cloud 840 would be understood by one of ordinary skill in the art.

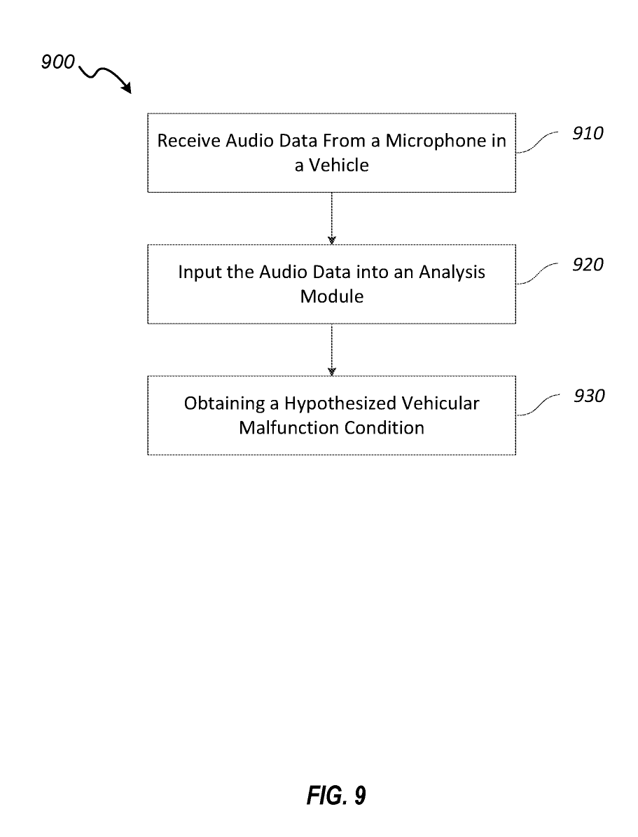

FIG. 9 shows a simplified flow chart 900 for automatically detecting vehicular malfunctions using audio signals, according to certain embodiments. Method 900 can be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 900 can be performed by processor 440 and logic block 450 of FIG. 4, one or more processors, or other suitable computing device.

At step 910, method 900 can include receiving audio data detected by at least one microphone (e.g., N1) placed on a vehicle (e.g., internal and/or external portion of vehicle 410). The audio data may correspond to sounds generated by the vehicle, such as the various vehicular components discussed above with respect to FIG. 1 (e.g., from suspension systems 120, steering control systems 130, engine 140, etc.).

At step 920, method 900 can include inputting the audio data into an analysis module having a trained model. The trained model can associate various audio data and corresponding vehicular malfunction conditions. The various audio data and corresponding vehicular malfunction conditions may be stored, e.g., in database 460, and may be provided by the vehicle manufacturer (e.g., pre-loaded at the time of manufacturing the vehicle), by other shared databases (e.g., via crowd sharing, the cloud, etc.), or a combination thereof. The various audio data can also be generated by the vehicle over time. For example, as new audio data arrives, it can be stored along with the various audio to build the data base of possible malfunction conditions.

At step 930, method 900 can include obtaining from the analysis module, a hypothesized vehicular malfunction condition based on the audio data. In some embodiments, logic 450 may hypothesize a vehicular malfunction condition by comparing the audio data with its database of various audio data and corresponding vehicular malfunctions. In certain embodiments, the trained model can be trained by machine learning. For example, as more input data is obtained and hypothesis are made, the analysis module can modify analyses based on previous outcomes (e.g., verified diagnoses), reinforcing data (e.g., other non-audio sensors corroborate hypothesized malfunction condition), or data from other sources (e.g., crowd sharing, centralized database, etc.). One of ordinary skill in the art would understand the many variations, modifications, and alternatives regarding aspects of machine learning. Some or all of the method steps of FIG. 9 can be performed in the vehicle (e.g., logic 450 and processor 460), or distributed between resources (e.g., in the cloud as show and described in FIG. 8).

It should be appreciated that the specific steps illustrated in FIG. 9 provides a particular method 900 of automatically detecting vehicular malfunctions using audio signals, according to certain embodiments. Other sequences of steps may also be performed according to alternative embodiments. For example, alternative embodiments may perform the steps outlined above in a different order. Moreover, the individual steps illustrated in FIG. 9 may include multiple sub-steps that may be performed in various sequences as appropriate to the individual step. Furthermore, additional steps may be added or removed depending on the particular applications. For example, sensor data (from non-audio sources) can be input into the analysis module, which may further associate the sensor data with the various audio sounds and corresponding vehicular malfunction conditions. One of ordinary skill in the art would recognize and appreciate many variations, modifications, and alternatives of the method 900.

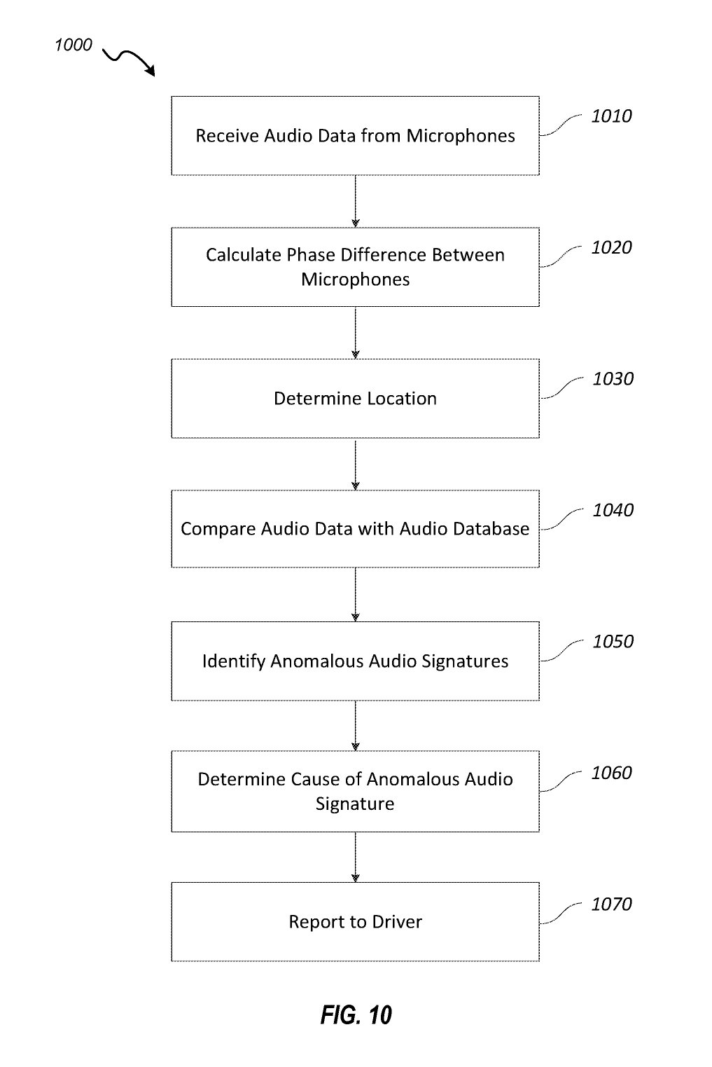

FIG. 10 shows a simplified flow chart 1000 for automatically detecting vehicular malfunctions using audio signals, according to certain embodiments. Method 1000 can be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 1000 can be performed by processor 440 and logic block 450 of FIG. 4, one or more processors, or other suitable computing device.

At step 1010, method 1000 can include receiving audio data detected by a microphone (e.g., N1) placed on a vehicle (e.g., internal and/or external portion of vehicle 410). The audio data may correspond to sounds generated by the vehicle, such as the various vehicular components discussed above with respect to FIG. 1 (e.g., from suspension systems 120, steering control systems 130, engine 140, etc.).

At step 1020, method 1000 can include comparing the audio data with reference audio data stored on an audio database. The reference audio data can include sounds generated by the vehicle under normal operating conditions. The audio database can be stored on the vehicle in a local memory, stored on a remote site (e.g., the cloud, other vehicles in a fleet, etc.), or a combination of both.

At step 1030, method 1000 can include identifying an anomalous audio signature in the audio data that differs from the sounds generated by the vehicle under normal operating conditions. Alternatively or additionally, the audio database can include sounds generated by the vehicle operating under one or more fault conditions, and method 1000 can further include comparing the anomalous audio signature in the audio data with the sounds generated by the vehicle operating under one or more fault conditions in the database, and identifying a match of the anomalous audio signature with the one or more sounds generated by the vehicle operating under one or more fault conditions.

It should be noted that the sounds generated by the vehicle can include detected and saved sounds collected from the particular vehicle over time (e.g., using machine learning), sounds corresponding to the particular make and model of the vehicle (e.g., provided by the vehicle manufacturer, crowd sourcing, etc.), or a combination thereof.

In some implementations, the audio data (including the anomalous audio signature) can be further received from one or more additional microphones disposed on the exterior portion of the vehicle. At step 1040, method 1000 may include determining a phase difference between the audio data received from the microphone and each of the one or more additional microphones. As discussed above, the microphones are placed at different locations on the vehicle. A sound (e.g., anomalous audio signature) generated by the vehicle will be detected by each microphone at a different time because their respective locations are at different positions with respect to the source of the sound. These different positions manifest as phase difference, also referred to as timing difference, in the audio data detected by each microphone.

At step 1050, method 1000 can include calculating a location of a source of the anomalous audio signature based on the calculated phase difference of the audio data corresponding to the anomalous audio signature received by the microphone and each of the one or more additional microphones.

At step 1060, method 1000 can include determining a cause of the anomalous audio signature based on at least one of corresponding audio characteristics of the anomalous audio signature, the match of the anomalous audio signature with the one or more sounds generated by the vehicle operating under one or more fault conditions, and the calculated location of the source of the anomalous audio signature.

It should be appreciated that the specific steps illustrated in FIG. 10 provides a particular method 1000 of automatically detecting vehicular malfunctions using audio signals, according to certain embodiments. Other sequences of steps may also be performed according to alternative embodiments. For example, alternative embodiments may perform the steps outlined above in a different order. Moreover, the individual steps illustrated in FIG. 10 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 1000.

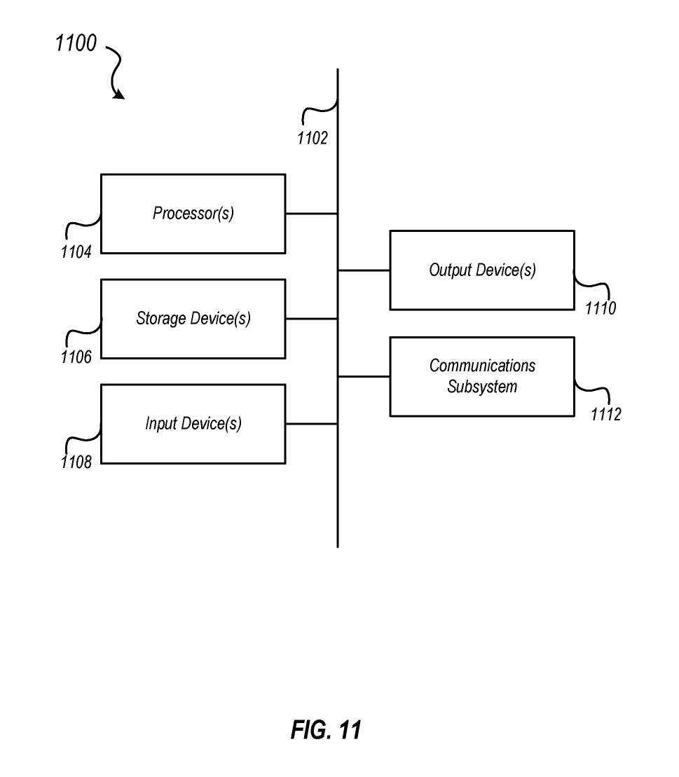

FIG. 11 is a simplified block diagram of computer system 1100 for performing certain aspects of automatically detecting vehicular malfunctions using audio signals, according to certain embodiments. Computer system 1100 can be used to implement any of the computer systems/devices (e.g., logic 450, database 460, processor(s) 440) described with respect to FIGS. 4-9. As shown in FIG. 11, computer system 1100 can include one or more processors 1104 to communicate with a number of peripheral devices via a bus subsystem 1102. These peripheral devices can include storage devices 1106 (including long term storage and working memory), user input devices 1108 (e.g. microphones N1-N4), user output devices 1110 (e.g., video display to communicate problem with vehicle based on method 900), and communications subsystems 1112.

In some examples, internal bus subsystem 1102 can provide a mechanism for letting the various components and subsystems of computer system 1100 communicate with each other as intended. Although internal bus subsystem 1102 is shown schematically as a single bus, alternative embodiments of the bus subsystem can utilize multiple buses. Additionally, communications subsystem 1112 can serve as an interface for communicating data between computer system 1100 and other computer systems or networks (e.g., in the cloud). Embodiments of communications subsystem 1112 can include wired interfaces (e.g., Ethernet, CAN, RS232, RS485, etc.) or wireless interfaces (e.g., ZigBee, Wi-Fi, cellular, etc.).

In some cases, user interface input devices 1108 can include a microphone, keyboard, pointing devices (e.g., mouse, trackball, touchpad, etc.), a barcode scanner, a touch-screen incorporated into a display, audio input devices (e.g., voice recognition systems, etc.), Human Machine Interfaces (HMI) and other types of input devices. In general, use of the term “input device” is intended to include all possible types of devices and mechanisms for inputting information into computer system 1100. Additionally, user interface output devices 1110 can include a display subsystem or non-visual displays such as audio output devices, etc. The display subsystem can be any known type of display device. In general, use of the term “output device” is intended to include all possible types of devices and mechanisms for outputting information from computer system 1100.

Storage devices 1106 can include memory subsystems and file/disk storage subsystems (not shown), which can be non-transitory computer-readable storage media that can store program code and/or data that provide the functionality of embodiments of the present disclosure (e.g., method 900). In some embodiments, storage devices 1106 can include a number of memories including main random access memory (RAM) for storage of instructions and data during program execution and read-only memory (ROM) in which fixed instructions may be stored. Storage devices 1106 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

Computer system 1100 might also include a communications subsystem 1112, which can include without limitation, a modem, a network card (wireless or wired), an infrared communication device, a wireless communication device and/or chipset (such as a Bluetooth device, an 802.11 device, a WiFi device, a WiMax device, cellular communication facilities, etc.), and/or the like. Communications subsystem 1112 may permit data to be exchanged with a network, other computer systems, and/or any other devices described herein. In many implementations, computer system 1100 can further comprise a non-transitory working memory, which can include a RAM or ROM device, as described above.

It should be appreciated that computer system 1100 is illustrative and not intended to limit embodiments of the present disclosure. Many other configurations having more or fewer components than system 1100 are possible.

Most embodiments utilize at least one network that would be familiar to those skilled in the art for supporting communications using any of a variety of commercially available protocols, such as TCP/IP, UDP, OSI, FTP, UPnP, NFS, CIFS, and the like. The network can be, for example, a local area network, a wide-area network, a virtual private network, the Internet, an intranet, an extranet, a public switched telephone network, an infrared network, a wireless network, and any combination thereof.

Non-transitory storage media and computer-readable storage media for containing code, or portions of code, can include any appropriate media known or used in the art such as, but not limited to, volatile and non-volatile, removable and non-removable media implemented in any method or technology for storage of information such as computer-readable instructions, data structures, program modules or other data, including RAM, ROM, Electrically Erasable Programmable Read-Only Memory (EEPROM), flash memory or other memory technology, CD-ROM, DVD or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments. However, computer-readable storage media does not include transitory media such as carrier waves or the like.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

What is claimed is:

1. A computer-implemented method for determining a vehicle malfunction, the method comprising:
receiving, by a processor, audio data from at least one microphone disposed on a vehicle, the audio data corresponding to sounds generated by the vehicle;
inputting, by the processor, the audio data into an analysis module having a trained model, the trained model associating various audio data and corresponding vehicular malfunction conditions; and
obtaining, by the processor, from the analysis module, a hypothesized vehicular malfunction condition based on the audio data.

2. The computer-implemented method of claim 1 further comprising:
inputting, by the processor, sensor data into the analysis module having the trained model, the sensor data from at least one sensor disposed on the vehicle,
wherein the trained model further associates various sensor data, along with the various audio sounds, and the corresponding vehicular malfunction conditions, and
wherein the hypothesized vehicular malfunction condition obtained from the analysis module is based on the audio data and the sensor data.

3. The computer-implemented method of claim 2 wherein the sensor data corresponds to at least one vehicle performance characteristic.

4. The computer-implemented method of claim 1 wherein the trained model is trained by machine learning.

5. The computer-implemented method of claim 1 further comprising:
receiving, by the processor, global positioning system (GPS) data corresponding to a present location of the vehicle,
wherein the hypothesized vehicular malfunction condition obtained from the analysis module is based on the audio data and the GPS data.

6. The computer-implemented method of claim 1 further comprising:
receiving, by the processor, traffic data corresponding to traffic local to a present location of the vehicle,
wherein the hypothesized vehicular malfunction condition obtained from the analysis module is based on the audio data and the traffic data.

7. The computer-implemented method of claim 1 wherein the various audio data and corresponding vehicular malfunction conditions are stored and retrieved from a database, and wherein the received audio data is added to the various audio data and corresponding vehicular malfunction conditions in the database.

8. A system comprising:
one or more processors; and
one or more non-transitory computer-readable storage mediums containing instructions configured to cause the one or more processors to perform operations including:
receiving, by a processor, audio data from at least one microphone disposed on a vehicle, the audio data corresponding to sounds generated by the vehicle;
inputting, by the processor, the audio data into an analysis module having a trained model, the trained model associating various audio data and corresponding vehicular malfunction conditions; and
obtaining, by the processor, from the analysis module, a hypothesized vehicular malfunction condition based on the audio data.

9. The system of claim 8 further comprising instructions configured to cause the one or more processors to perform operations including:
inputting, by the processor, sensor data into the analysis module having a trained model, the sensor data from at least one sensor disposed on the vehicle, wherein the trained model further associates various sensor data, along with the various audio sounds, and the corresponding vehicular malfunction conditions, and
wherein the hypothesized vehicular malfunction condition obtained from the analysis module is based on the audio data and the sensor data.

10. The system of claim 9 wherein the sensor data corresponds to at least one vehicle performance characteristic.

11. The system of claim 8 wherein the trained model is trained by machine learning.

12. The system of claim 8 further comprising instructions configured to cause the one or more processors to perform operations including:
receiving, by the processor, GPS data corresponding to a present location of the vehicle,
wherein the hypothesized vehicular malfunction condition obtained from the analysis module is based on the audio data and the GPS data.

13. The system of claim 8 further comprising instructions configured to cause the one or more processors to perform operations including:
receiving, by the processor, traffic data corresponding to traffic local to a present location of the vehicle,
wherein the hypothesized vehicular malfunction condition obtained from the analysis module is based on the audio data and the traffic data.

14. The system of claim 8 wherein the various audio data and corresponding vehicular malfunction conditions are stored and retrieved from a database, and wherein the received audio data is added to the various audio data and corresponding vehicular malfunction conditions in the database.

15. A system for determining a vehicle malfunction, the system comprising:
means for receiving audio data from at least one microphone disposed on a vehicle, the audio data corresponding to sounds generated by the vehicle;
means for inputting the audio data into an analysis module having a trained model, the trained model associating various audio data and corresponding vehicular malfunction conditions; and
means for obtaining from the analysis module, a hypothesized vehicular malfunction condition based on the audio data.

16. The system of claim 15 further comprising:
means for inputting sensor data into the analysis module having a trained model, the sensor data from at least one sensor disposed on the vehicle,
wherein the trained model further associates various sensor data, along with the various audio sounds, and the corresponding vehicular malfunction conditions, and
wherein the hypothesized vehicular malfunction condition obtained from the analysis module is based on the audio data and the sensor data.

17. The system of claim 16 wherein the sensor data corresponds to at least one vehicle performance characteristic.

18. The system of claim 15 wherein the trained model is trained by machine learning.

19. The system of claim 15 further comprising:
means for receiving GPS data corresponding to a present location of the vehicle,
wherein the hypothesized vehicular malfunction condition obtained from the analysis module is based on the audio data and the GPS data.

20. The system of claim 15 further comprising:
means for receiving traffic data corresponding to traffic local to a present location of the vehicle,
wherein the hypothesized vehicular malfunction condition obtained from the analysis module is based on the audio data and the traffic data.
